(19) United States
(12) Patent Application Publication
(10) Pub. No.: US 2024/0364585 A1
(43) Pub. Date: Oct. 31, 2024

(54) GENERATING ENHANCED DESCRIPTIONS OF DETECTED NETWORK EVENTS FOR EFFICIENT HUMAN INTERPRETATION AND RESPONSE

(71) Applicant: Netography, Inc., Annapolis, MD (US)

(72) Inventor: Barrett Lyon, Miami, FL (US)

(21) Appl. No.: 18/645,921

(22) Filed: Apr. 25, 2024

Related U.S. Application Data
(60) Provisional application No. 63/461,899, filed on Apr. 25, 2023.

(51) Int. Cl. H04L 41/069; H04L 9/40; H04L 41/16

(52) U.S. Cl. CPC H04L 41/069; H04L 41/16; H04L 63/1416

(57) ABSTRACT

Various techniques for generating enhanced descriptions of detected network events for efficient human interpretation and response are disclosed. In some embodiments, event data associated with a detected network event is analyzed using an artificial intelligence based framework, and an output is generated using the artificial intelligence based framework that comprises a description of the detected network event.

### CROSS REFERENCE TO OTHER APPLICATIONS

This application claims priority to U.S. Provisional Patent Application No. 63/461,899 entitled ENHANCED NETWORK ALERT SYSTEM FOR EFFICIENT HUMAN INTERPRETATION AND RESPONSE filed Apr. 25, 2023 which is incorporated herein by reference for all purposes.

### BACKGROUND OF THE INVENTION

Multiple alerts are typically generated in response to a detected network event and are generally difficult to comprehensively interpret. Thus, there exists a need for improved techniques for interpreting event data associated with detected network events.

### BRIEF DESCRIPTION OF THE DRAWINGS

Various embodiments of the invention are disclosed in the following detailed description and the accompanying drawings.

FIG. 1 is a high level block diagram illustrating an embodiment of an architecture of the disclosed network and security operations platform.

FIG. 2 is a high level flow chart illustrating an embodiment of a process for automatically generating a network and/or security response for a monitored private network from an external service.

FIG. 3 is a high level flow chart illustrating an embodiment of a process for automatically generating a security response for a monitored private network from an external service.

FIG. 4 is a high level block diagram illustrating an embodiment of an architecture of the disclosed artificial intelligence based framework.

FIG. 5 is a high level flow chart illustrating an embodiment of a process for generating a language model.

FIG. 6 is a high level flow chart illustrating an embodiment of a process for generating a description of a detected network event.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims, and the invention encompasses numerous alternatives, modifications, and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

Network and security operations are essential for any complex networking environment deployed by an enterprise or organization. A network is typically managed by a network operations center (NOC) via which network monitoring and control are facilitated. Security of a network is typically provided by a security operations center (SOC) via which detection, containment, and remediation of threats and attacks to the network are facilitated. Thus, network and security operations have traditionally been segregated. More recently, there exists an ongoing effort of bringing NOCs and SOCs closer together and leveraging the benefits of combining network and security operations.

A fusion network and security operations platform uniting network operations and security operations is disclosed herein. The disclosed platform comprises an out-of-band, cloud-based service that can be used on any network as a software as a service (SaaS). In some embodiments, the disclosed platform comprises a distributed intrusion detection and prevention system that is complementary to any existing security deployments on a monitored network. The network and security operations platform leverages the relatively unlimited computational power of the cloud to provide an additional layer of control and security to a monitored network, which by itself is limited in computational resources available for network and security operations. A monitored network may be dynamically and automatically optimized and secured, with or without human operator direction or intervention, based on remote monitoring and analysis. Moreover, remote tools associated with the service provide unprecedented monitoring and visualization of the monitored network.

As further described in detail herein, the disclosed platform collects real-time data from a monitored network in a decentralized cloud service where the collected data is analyzed according to a set of one or more proprietary system and/or user-definable custom algorithms. Alerts or actions against any network or security events detected in the analyzed data of the monitored network are automatically provided and/or performed in nearly real-time, for example, via an associated portal having a dashboard with user interface gauges and tools that provide situational awareness of the monitored network, via integration of an associated application programming interface (API) with existing network or security operations tools of the monitored network, and/or via appropriate adjustment of network routing policies by communication with network edge devices such as routers, switches, and cloud services.

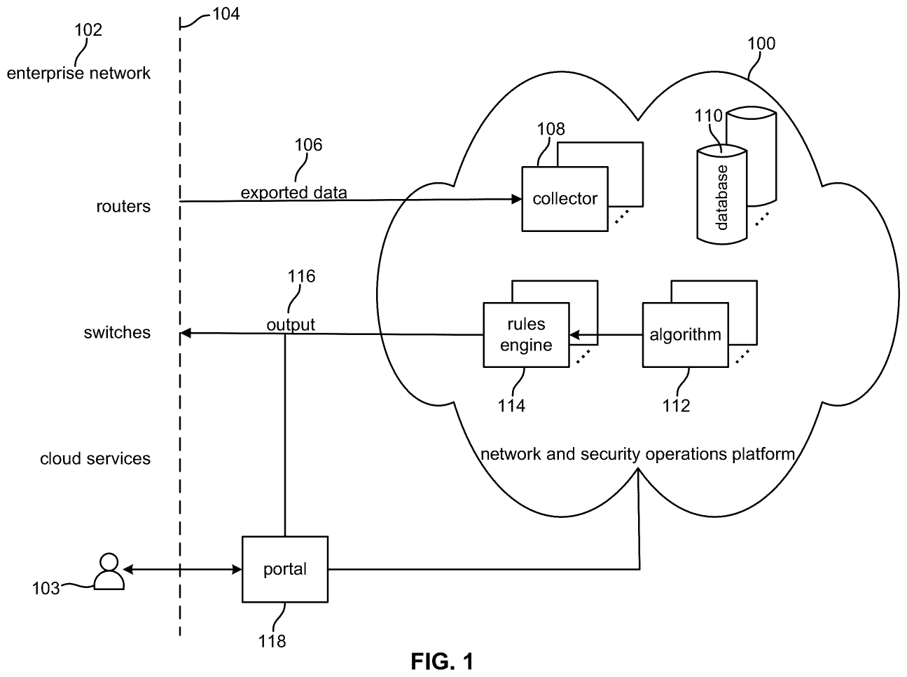

FIG. 1 is a high level block diagram illustrating an embodiment of an architecture of the disclosed network and security operations platform. Generally, network and security operations platform 100 may be employed to automatically defend monitored network 102 from threats and attacks, manage and optimize monitored network 102, and keep operators 103 of monitored network 102 informed of the current state of the network and nodes thereof, all in nearly real-time.

In some embodiments, network and security operations platform 100 is employed to provide an additional layer of security to monitored network 102 beyond any existing security measures already deployed in the network, such as firewalls and access-control lists (ACLs) on edge or border devices of the network. Network and security operations platform 100 may be employed to detect threats and attacks, anomalous usage behaviors, unusual protocols, dangerous networks, etc. Some examples of security events that may be handled by network and security operations platform 100 include distributed denial-of-service (DDoS) attacks, bots and botnets, unauthorized data extraction, port scans, enumeration attempts, and repeated login attempts. Some examples of security services provided by network and security operations platform 100 include cyber forensics, DDoS defenses, attack surface protection, access control list (ACL) management, active Internet Protocol (IP) reputation monitoring, data loss prevention (DLP), and remotely-triggered black hole (RTBH) routing.

Network and security operations platform 100, however, is not limited to detecting and responding to security events and providing security services but may also be employed to detect and respond to network operations events and provide network operations services with respect to monitored network 102. For example, network and security operations platform 100 may be employed to manage network resources and infrastructure, detect network saturation points, modify or optimize routes, ensure quality of service (QoS), manage bandwidth, facilitate billing services, etc.

Although a few components of network and security operations platform 100 are illustrated in FIG. 1 to describe the architecture of the platform, network and security operations platform 100 may generally have any appropriate types, numbers, and combinations of distributed and networked components. For example, although not depicted in FIG. 1, network and security operations platform 100 comprises a plurality of processing cores and associated memories. Various features of the disclosed network and security operations platform 100 are next described with respect to the network environment illustrated in FIG. 1.

In the example of FIG. 1, monitored network 102 comprises a private, enterprise network. Enterprise network 102 has an edge or border 104 defined by the physical devices and virtual services that collectively form the edge or border of the network. In the past, a network edge or border was typically constrained to devices such as routers and switches that were deployed in a controlled, private network environment. As networks have evolved, the network edge or border has also substantially spread across a plurality of external, third-party providers, such as providers of virtual private cloud (VPC) services. Thus, network perimeters have virtually disappeared, and borders have become fractured and decentralized.

By collecting and combining data both from physical edge or border devices comprising a private network (e.g., routers and switches) and from virtual service providers scattered across the Internet, the disclosed network and security operations platform facilitates unifying network and security control with near real-time coordination and situational awareness from a single point, effectively creating a synthetic border for a private, enterprise network. With respect to FIG. 1, for example, network and security operations platform 100 provides a wholistic view into private enterprise network 102 as well as a defined synthetic edge or border 104 of the network. More specifically, network and security operations platform 100 comprises a central point for receiving data from multiple physical and virtual nodes of network 102 and comprehensively viewing the entire network 102 as well as analyzing received data and facilitating appropriate alerts and actions in response to detected network and security events.

A response by network and security operations platform 100 with respect to a particular node or device of network 102 may be quickly scaled to the entire network. For example, network and security operations platform 100 may preemptively identify and remedy suspicious behavior at other nodes based on a detected security event at one of the network nodes. Moreover, since the services of network and security operations platform 100 are employed by several different private networks, security events detected and corrected on one network may in real-time be prevented or corrected on one or more other networks that network and security operations platform 100 monitors. That is, network and security operations platform 100 has a comprehensive view across multiple private networks, and, thus, has the benefit of being able to more quickly and automatically learn and identify similar events and patterns and respond with appropriate actions.

In the environment of FIG. 1, network appliances (e.g., routers and switches) and cloud services (e.g., VPC services) that define the edge or border 104 of network 102 are configured to export data 106 useful for network and security operations to network and security operations platform 100. For example, data 106 may comprise lightweight protocols such as network flow data and (e.g., system and/or server) log data. More specifically, in some embodiments, data 106 comprises any data or information that defines network communications but that does not have any payload or other sensitive (e.g., user-specific) information. In some cases, data 106 comprises a substantially continuous stream of data from network 102. However, data 106 may comprise sampled data rather than full packet capture data. Moreover, data 106 may be compressed and/or encrypted. Data 106 may be communicated from private network 102 to network and security operations platform 100 via a public network such as the Internet.

In some embodiments, network and security operations platform 100 is based on network flow data. That is, data 106 comprises flow records exported by network devices such as routers and switches as well as VPC services. Generally, a network flow refers to a communication channel between two end points or hosts bound by a session. More specifically, a network flow is defined as a unidirectional sequence of packets that share the same values for fields such as source IP address, destination IP address, source port, destination port, protocol type, type of service (ToS), and/or ingress interface. That is, a flow specifies a prescribed communication channel for a particular session, and packets sharing the same values for at least a subset of the aforementioned fields belong to the same flow. Many network devices (e.g., routers and switches) and cloud services (e.g., VPC services) are configured to extract measurements and data associated with a given flow and export such data for further analysis. Such a flow record may include various types of information including, for example, timestamps of the first and last packets of the flow, total number of bytes and packets observed in the flow, source/destination IP addresses, source/destination ports, protocol type, type of service (ToS) value, Transmission Control Protocol (TCP) flags, routing information, I/O interface index information, and other details. The precise information extracted from a flow varies by provider and depends on both the device or service that generates the flow data as well as the protocol used to export the information.

Flow data has not been exploited much beyond its typical use for traffic engineering and routing. Flow data has been used in the past to detect DDoS attacks and trigger route changes to dedicated devices configured to handle such attacks. The use of flow data in the security realm has been limited largely because the data is sampled, i.e., the data is incomplete. However, despite being sampled, flow data can be leveraged for a variety of purposes. In some embodiments, the disclosed network and security operations platform 100 is configured to provide a full range of network and security services based on flow data. More specifically, network and security operations platform 100 is configured to receive, process, and store flow data as well as leverage flow data for network and security operations. Moreover, network and security operations platform 100 comprises a single, unified platform that supports a plurality of industry standard flow protocols, including, but not limited to, Internet Protocol Flow Information Export (IPFIX), NetFlow, SFlow, JFlow, VPC Flow Logs, etc. The algorithms and corresponding thresholds employed by network and security operations platform 100 may at least in part be based on the sampling rates of received flow data since different network nodes may have different sampling rates. Moreover, network and security operations platform 100 may be configured to automatically adjust the sampling rates of the flow data of nodes in network 102 via communication with the nodes or through an associated API.

Returning back to the description of the network environment of FIG. 1, data 106 from network 102 may be received, for example, by one or more distributed data collectors comprising network and security operations platform 100, such as data collector 108. Within network and security operations platform 100, received data 106 and/or parts thereof may be analyzed for network and security events; indexed for searchability; optionally enriched or tagged with applicable metadata or tags such as security, business, and/or performance details; and/or stored in one or more associated databases, such as database 110.

Various appropriate alerts or actions may be initiated or facilitated by network and security operations platform 100 in response to inferences made from analyzing received data 106. Real-time and/or historic monitoring and analysis of received data 106 may be performed by a set of one or more network and/or security algorithms 112. In various embodiments, the set of algorithms 112 may comprise one or more system algorithms generally applied across all data input into network and security operations platform 100, one or more algorithms customized for a prescribed enterprise network 102, one or more user-defined algorithms specified by operators 103 of network 102, or any combination thereof. Algorithms 112 are configured to identify network performance and security events such as anomalies, failures, threats, attacks, etc., in data 106 and generate appropriate alerts. Alerts on any network or security events detected by algorithms 112 are routed to one or more appropriate rules engines, such as rules engine 114. Rules engine 114 implements rules for responding to alerts generated by algorithms 112. That is, rules engine 114 facilitates one or more appropriate actions in response to detected network performance and/or security events by algorithms 112. In various embodiments, events or alerts may be mapped by rules engine 114 to default actions, and/or custom, user-definable actions may be specified for various events or alerts by users of network and security operations platform 100, such as by operators 103 of network 102. Examples of actions facilitated by rules engine 114 include dropping or simply logging a detected event or generated alert, providing a corresponding alert or notification via one or more channels, highlighting or providing another visual indication of a detected event or generated alert with respect to a graphical user interface element or tool used to display related data, facilitating route changes (such as for active blocking) by communicating with affected network nodes, etc. An output 116 generated by network and security operations platform 100 may be directly communicated to one or more applicable network nodes, may be made available and/or presented via a portal 118 of network and security operations platform 100 associated with a prescribed user or network account, and/or may be integrated via an associated API or plug-in with existing network tools or services, such as security information and event management (SIEM) services, Slack, Trilio, Webhook, e-mail, short message service (SMS), automated scripts, etc.

A key feature of network and security operations platform 100 is facilitating dynamic and automatic route filtering, manipulation, and/or modification via communication with network edge nodes based on detected network and security events. From a security perspective, for example, this feature of network and security operations platform 100 may be employed for automatically adjusting, changing, or reconfiguring security policies, (VPC) security groups, access control lists (ACLs), etc., at one or more nodes of network 102 based on detected security threats and breaches. In some cases, output 116 comprises streaming real-time filter information (e.g., IP addresses to block) to edge or border nodes of network 102. Network and security operations platform 100 may communicate with network nodes via any appropriate communication protocol, such as Border Gateway Protocol (BGP), Flowspec, APIs, etc. Such protocols for route control have typically only been used by operators 103 of a given network 102 that are on the network 102. However, network and security operations platform 100 leverages remote triggering of such protocols to provide a further layer of control and security as well as to further automate network routing. For example, remote-triggering may be employed to inject a prescribed rule (e.g., route) into a monitored network and force network nodes to drop all traffic with a prescribed next-hop.

Network and security operations platform 100 effectively facilitates a new paradigm for network security by blocking intrusion events a posteriori, i.e., after they have been detected, compared to the typical security ethos of blocking a priori, i.e., before intrusions occur. Attempts to block malicious traffic before the traffic ever enters a network coupled with limitations in available computational resources at network end points has resulted in severe scalability setbacks for existing intrusion detection and prevention systems, especially as rule and signature complexities have grown. Scalability has further been limited because such systems attempt to block all known malicious traffic. However, reputation databases have become too large to be completely incorporated in end point access control lists. Thus, existing systems suffer security vulnerabilities. Such vulnerabilities are addressed by the disclosed network and security operations platform 100. Unprecedented scalability is feasible with the nearly limitless availability of processing and storage resources on the cloud but at the expense of introducing a trivial amount of latency between detection and remediation of an event such as a breach or attack. However, such a latency typically spans a time duration (e.g., of a few seconds) during which malicious activity is unable to detrimentally impact or otherwise significantly compromise the monitored network.

Thus, network and security operations platform 100 facilitates significantly more comprehensive security monitoring while having relatively limitless data processing and storage resource availability for analyzing received data with respect to algorithms, rules, signatures, reputation databases, etc. Network and security operations platform 100 delivers security responses in nearly real-time. That is, post detection, malicious or potentially malicious traffic is blocked using existing network infrastructure such as routers, switches, policy groups, DevOps calls to an associated API, etc. In some embodiments, network and security operations platform 100 only blocks bad or malicious traffic that has been detected, so any generated filters or block lists output by network and security operations platform 100 scale easily with respect to the capacities of access control lists of network nodes. This is in contrast to existing systems that attempt to block all known bad or malicious traffic regardless of whether such traffic has actually been seen on the network and as a result are limited by access control list capacities at network end points. In some embodiments, in order to provide a failsafe against false positives, network and security operations platform 100 is configured to block only individual IP address, i.e., single hosts, instead of large IP address blocks and/or to block only for prescribed (user-definable) time durations. Furthermore, network and security operations platform 100 provides an additional layer of security on top of any existing security measures already deployed on the monitored network. Thus, any malicious traffic not detected or not detected quickly enough may be detected by such existing security systems of the monitored network.

Each network monitored by network and security operations platform 100, such as network 102, has a prescribed user or network account with network and security operations platform 100 and associated portal 118. Portal 118 provides a set of interfaces into network and security operations platform 100 via which various services associated with network and security operations platform 100 may be selected, specified, and/or configured and via which data collected, processed, and stored by network and security operations platform 100 may be aggregated, displayed or visualized (e.g., via charts and graphs), queried, analyzed, or otherwise accessed. A central point is provided by portal 118 from which network operation teams, security operation teams, and developers associated with network 102 can operate their network and security posture. Portal 118 provides a customizable dashboard with user interface elements and tools for identifying, processing, analyzing, displaying, and generally comprehending real-time and historical information associated with monitored network 102. Furthermore, portal 118 provides user interfaces for writing custom scripts or algorithms, specifying or configuring thresholds and rules, and defining alerts or actions for detected events. A unified portal 118 allows different teams (e.g., SOC, NOC, DevOps, and business leaders) to use the same data and toolsets, resulting in reduced mean time to resolve detected network and security events. Moreover, by leveraging an API associated with network and security operations platform 100, different teams can apply unique business logic to their data to create actionable custom tools, for example, for managing security threats, route management, billing systems, etc.

In some embodiments, an easy-to-use, propriety query language is employed to better unify network and security operations platform 100, portal 118, and associated APIs and plug-ins. The query language associated with network and security operations platform 100 may be employed, for example, for tasks such as searching data, alerts, and interfaces; filtering statistics and aggregations; defining custom algorithms to alert on; etc. As previously described, tags may be added to received data records 106. Such tags are available for use with respect to portal 118, an associated API, and the proprietary query language. Software may be created around such simple tags/text. Leveraging tags throughout network and security operations platform 100 is helpful for keeping terminology consistent and to resolve complex data to human readable formats. Tags also allow for multi-tenant separation of data. In addition, tags may be used to associate customers, departments, locations, etc., to an IP address, autonomous system number (ASN), etc.

As described, comprehensive network and security operations tools and services are provided by network and security operations platform 100 as well as its associated portal 118, APIs, and plug-ins. Although some features have been described, the disclosed platform may generally be appropriately scaled and adjusted to provide any needed network and/or security operations services.

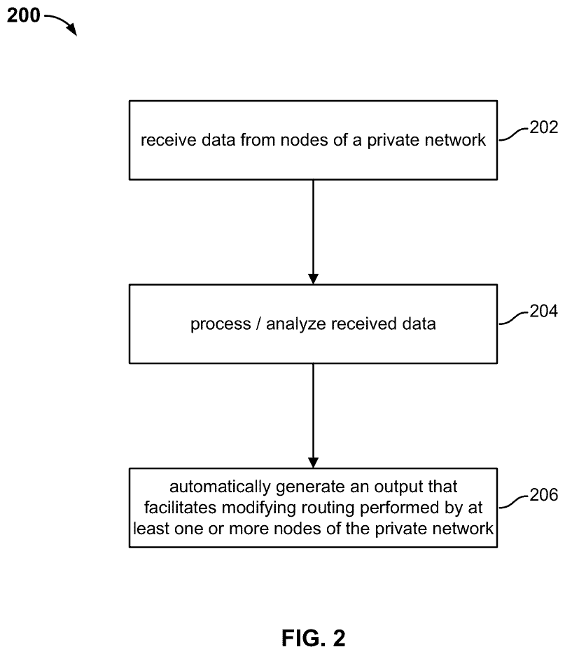

FIG. 2 is a high level flow chart illustrating an embodiment of a process for automatically generating a network and/or security response for a monitored private network from an external service. Process 200 may be employed, for example, by network and security operations platform 100 of FIG. 1.

At step 202, data is received from one or more nodes of a private, enterprise network. More specifically, data is received at step 202 by a network and security operations service that is external to the private network such as a distributed, cloud-based service such as network and security operations platform 100 of FIG. 1. The received data may comprise nearly continuous data streams transmitted by edge or border nodes comprising the private network, such as routers, switches, cloud services, etc. In some cases, the received data is sampled, and different nodes of the private network may export data with different sampling rates. In some embodiments, the received data comprises lightweight protocols that do not have any payload or other sensitive information but rather basic information that specifies network communications such as flow data and log data protocols.

At step 204, the data received at step 202 is processed and analyzed. In various embodiments, step 204 may include analyzing the data for network performance and/or security events, for example, using various algorithms and rules; generating alerts and notifications on the data based on associated thresholds; indexing the data for searchability; enriching or tagging the data with applicable metadata or tags; storing or persisting the data in databases; presenting and generally making the data available with respect to an associated portal of the external service; etc.

At step 206, an output is automatically generated that facilitates modifying the routing performed by at least one or more nodes of the private network. For example, the output may be automatically generated at step 206 in response to detecting a network performance or security event at step 204 and may be generated by a rules engine that is configured to map a detected event to an action according to one or more rules. In some embodiments, the output facilitates route filtering, manipulation, and/or modification in the private network or nodes thereof. For example, the output may comprise a routing filter or block list. The output generated at step 206 may be communicated to nodes of the private network via BGP, FlowSpec, or an API associated with the external service. In some embodiments, the generated output or a notification or other associated information thereof may additionally be automatically made available via an associated portal of the external service and/or a third-party application with which the external service is integrated.

Process 200 may be employed to facilitate management and optimization of the private network as well as to defend the private network from threats and attacks. A nearly real-time and, in many cases, completely automatic response is generated as network and security events are detected in received data.

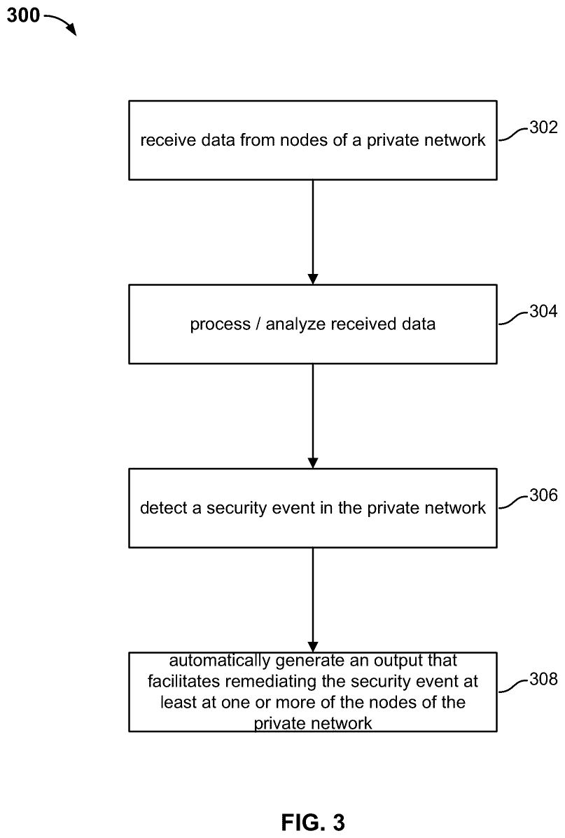

FIG. 3 is a high level flow chart illustrating an embodiment of a process for automatically generating a security response for a monitored private network from an external service. Process 300 may be employed, for example, by network and security operations platform 100 of FIG. 1.

At step 302, data is received from one or more nodes of a private, enterprise network. More specifically, data is received at step 302 by a security service that is external to the private network such as a distributed, cloud-based service such as network and security operations platform 100 of FIG. 1. In some cases, the security service comprises a distributed intrusion detection and prevention system. The received data may comprise nearly continuous data streams transmitted by edge or border nodes comprising the private network, such as routers, switches, cloud services, etc. In some cases, the received data is sampled, and different nodes of the private network may export data with different sampling rates. In some embodiments, the received data comprises lightweight protocols that do not have any payload or other sensitive information but rather basic information that specifies network communications such as flow data and log data protocols.

At step 304, the data received at step 302 is processed and analyzed. In various embodiments, step 304 may include analyzing the data for security events using various algorithms and rules; generating alerts and notifications on the data based on associated thresholds; indexing the data for searchability; enriching or tagging the data with applicable metadata or tags; storing or persisting the data in databases; presenting and generally making the data available with respect to an associated portal of the external service; etc.

At step 306, a security event in the private network is detected from analyzing the data at step 304. For example, the security event may be associated with a DDoS attack, bot or botnet, unauthorized data extraction, port scan, enumeration attempt, repeated login, etc.

At step 308, an output is automatically generated in response to detecting the security event at step 306 that facilitates remediating the security event at least at one or more of the nodes of the private network. For example, the output may be automatically generated at step 308 by a rules engine that is configured to map a detected security event to an action according to one or more rules. In some embodiments, a latency exists between the security event occurring on the private network and being remediated during which time an entity responsible for the security event has access to the private network but, in most cases, not long enough to detrimentally affect or otherwise substantially compromise the network. In some embodiments, the output comprises a routing filter or block list. The output generated at step 308 may be communicated to nodes of the private network via BGP, FlowSpec, or an API associated with the external service. In some embodiments, the generated output or a notification or other associated information thereof may additionally be automatically made available via an associated portal of the external service and/or a third-party application with which the external service is integrated.

Process 300 may be employed to defend the private network from threats and attacks. A nearly real-time and, in many cases, completely automatic response is generated as security events are detected in received data. In some embodiments, (IP address) blocking is only performed with respect to threats or attacks that are actually detected so that blocking does not extend beyond the (e.g., ACL) capacities and capabilities of edge nodes. Moreover, blocking may be limited to single hosts and/or prescribed time durations.

As described, the disclosed network and security operations platform generates alerts or notifications for detected network performance or security events through various methods, including real-time data reception, post-processing of stored data, side-car software models, etc. In many cases, the network and security operations platform generates a plurality of associated alerts or notifications for a detected event. A set of generated alerts or notifications associated with a detected event is analyzed for a more comprehensive understanding of the detected event. Such analysis may comprise, for example, interpretation and correlation of event data to generate situational awareness of an associated event. Analysis of event data may at least in part be facilitated by human analysts. In many cases, however, typical formats for presenting event data (e.g., X detected at Y time 1000 times from N number of locations or sources, with a set of associated labels) do not provide enough actionable context for users to effectively respond to complex issues, such as network saturation or targeted attacks by hackers.

An artificial intelligence (AI) or machine learning (ML) based framework or architecture for generating an enhanced description of a detected network event for more efficient human interpretation and response is disclosed herein and described next. In some embodiments, the artificial intelligence based framework comprises network and security operations platform 100 of FIG. 1. The disclosed artificial intelligence based framework automates alert analysis and summary or report generation, eliminating the need for human analysis of event data. More specifically, the disclosed artificial intelligence based framework employs one or more language models to automatically aggregate, format, and enrich presentation of event data into a single summary that enables a user to more efficiently interpret and respond to alerts generated by network and security operations platform 100 for a detected network event.

The disclosed artificial intelligence based framework provides various useful features that collectively facilitate improved human understanding of network performance and security events in a monitored network. For example, as described, the disclosed artificial intelligence based framework facilitates aggregation and summarization of event data. That is, event data associated with a detected network event is collected and analyzed to provide an overview, summary, or report of detected activities associated with the event, optionally with key information such as number of occurrences, times of occurrences, locations, sources involved, etc., highlighted for emphasis. Event data associated with a detected network event may generally comprise a plurality of one or more types of alerts or notifications or other data generated in response to processing of network data by algorithms configured to identify or detect events in a network being monitored. In some cases, the disclosed artificial intelligence based framework facilitates aggregation and summarization of a plurality of alerts associated with a detected network event to generate a single super or master or uber alert that provides a better and more concise description of the plurality of alerts.

In addition, the disclosed artificial intelligence based framework facilitates correlation of event data and identification of patterns in event data. That is, advanced analytics and machine learning based algorithms are employed to analyze and correlate event data associated with a detected network event, which in many cases results in the revelation of relationships between seemingly unrelated activities and identification of patterns indicative of more serious issues, such as network saturation or coordinated attacks. Moreover, the disclosed artificial intelligence based framework provides enhancement of context by facilitating discovery of relevant tags, labels, and metadata. That is, one or more appropriate tags, labels, and metadata are identified and associated with a detected network event or a generated summary or report thereof to provide additional context to users, aiding in understanding of event significance and potential impact. Furthermore, the disclosed artificial intelligence based framework facilitates generation of actionable insights and recommendations. That is, users are provided with clear, actionable insights into and recommendations for detected events, enabling more informed decisions and more effective responses to identified issues. In some cases, such insights and recommendations are parts of the summaries or reports generated for detected events.

As described, instead of raw event data entries, a single summary or report that aggregates and summarizes a plurality of event data entries associated with a prescribed network event is presented along with insights and recommendations for response, which a user may employ to initiate appropriate remediation actions. A generated summary or report may be presented in natural language and with terminology that is understandable to a target user. In some embodiments, a generated summary or report of a detected event is customized based on a position or role in an organization of a user for whom the report is generated. That is, generated summaries or reports may be specifically tailored to various stakeholders responsible for managing an associated network such as network operations experts, network security experts, chief information security officer, etc., with different versions of the summaries or reports generated for different types of users.

Generally, the disclosed artificial intelligence based framework empowers users to make more informed decisions and respond more efficiently to detected network issues, improving overall network performance and security. In a first embodiment, the disclosed artificial intelligence based framework comprises a single, unified framework that serves all networks with the same base knowledge and prompting techniques, allowing for more efficient resource utilization. In a second embodiment, the disclosed artificial intelligence based framework comprises a network-specific framework that generates real-time contextual prompts and processes event data in isolation from data from other networks, preventing cross-contamination and ensuring accuracy. While this second embodiment may be more resource-intensive, the second embodiment provides a tailored experience for each network, adapting to the unique naming conventions and data descriptions of that network. Both embodiments aim to deliver accurate and actionable insights to network stakeholders, with the choice between a single, unified framework for efficiency or a network-specific framework for enhanced accuracy and customization.

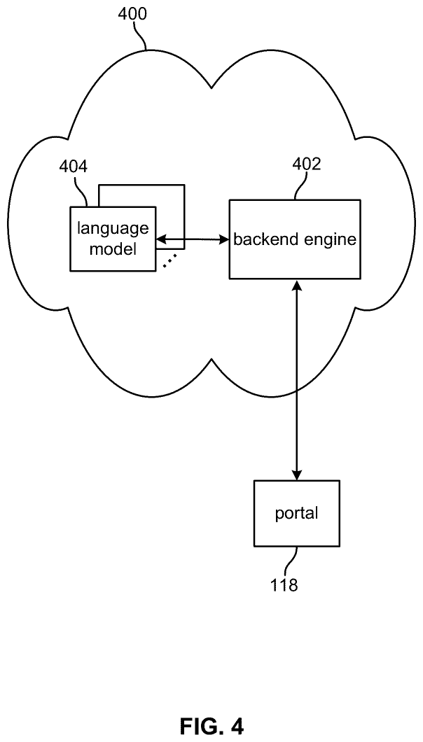

FIG. 4 is a high level block diagram illustrating an embodiment of an architecture of the disclosed artificial intelligence based framework 400. As depicted in FIG. 4, artificial intelligence based framework 400 comprises a backend service or engine 402 that interfaces with one or more language models such as language model 404. In some embodiments, artificial intelligence based framework 400 comprises an external, cloud-based service, i.e., network and security operations platform 100 of FIG. 1. Algorithms 112 of network and security operations platform 100 process received network data 106 and facilitate detection of relevant event data, such as alert or notification data, which may be persisted in one or more databases 110 of network and security operations platform 100. Backend engine 402 interfaces with various components of and in some cases comprises a search engine into network and security operations platform 100. Moreover, in some embodiments, backend engine 402 comprises a dedicated API (Application Programming Interface) that connects language models 404 and portal 118 of network and security operations platform 100.

Tasks handled by backend engine 402 may include, for example, processing and validation of (API) requests, facilitating generation of summaries or other event descriptions via language models 404, managing request queueing and prioritization, facilitating storage of outputs generated by language models 404, etc. Event data associated with a detected network event and/or customer specific context are retrieved by backend engine 402 and communicated to or input into language models 404 for analysis, and, in response, backend engine 402 receives one or more outputs generated by language models 404, such as summary or other data that provides a description of the detected network event. As depicted in FIG. 4, backend engine 402 interfaces with portal 118 of network and security operations platform 100 to facilitate fetching of data from portal 118 and updating of data of portal 118. Such integration with portal 118 facilitates access to network-specific data and event information, which is useful for generating custom summaries, insights, and recommendations for the associated network. A dedicated API comprising backend engine 402 that interfaces with models 404 and portal 118 provides a seamless manner for network stakeholders to request and manage summaries on-demand and also facilitates an interactive investigate tool via which users can learn about their network, network data, and detected network events in depth. In some embodiments, portal 118 supports conversational artificial intelligence or speech-to-text features for casier interaction with end users. Artificial intelligence based framework 400 generally ensures that users have easy access to relevant data as well as insights and recommendations so that informed decisions about network operations, network security, and cybersecurity strategies can be made as needed.

Artificial intelligence based framework 400 comprises one or more generic or custom language models 404 that are trained to possess extensive knowledge of network operations, network security, cybersecurity, and other relevant terminology needed to effectively communicate with network operations experts, network security experts, chief information security officers, and others in the field. Language models 404 are at least in part trained on event data or alert data generated by algorithms 112 rather than raw network data 106 received by network and security operations platform 100. In some embodiments, artificial intelligence based framework 400 comprises one or more natural language processing (NLP) models 404. In some embodiments, artificial intelligence based framework 400 comprises one or more large language models (LLMs) 404. In some embodiments, one or more language models 404 comprise one or more deep learning models or transformers such as GPT (Generative Pretrained Transformer) or BERT (Bidirectional Encoder Representations from Transformers).

A language model may be trained on internal context, API calls, and various technology-related data (e.g., airport codes, data center locations, network protocols, etc.) to ensure a deep understanding of the underlying subject matter. Moreover, contextual prompting facilitates mapping of network specific context (e.g., server names, device names, network segments, virtual private clouds, domain name systems, etc.) to respective identifiers (e.g., IP addresses) and thus providing a comprehensive understanding of the unique environment and infrastructure of a prescribed network, allowing the model to generate more accurate and relevant insights and recommendations for that network. After establishing initial context, a language model imports event data (e.g., alert data), processes this data, and answers a series of questions formulated to give a deeper understanding of network events and their potential impact, ultimately enabling the model to provide more detailed and actionable insights and recommendations to various network stakeholders.

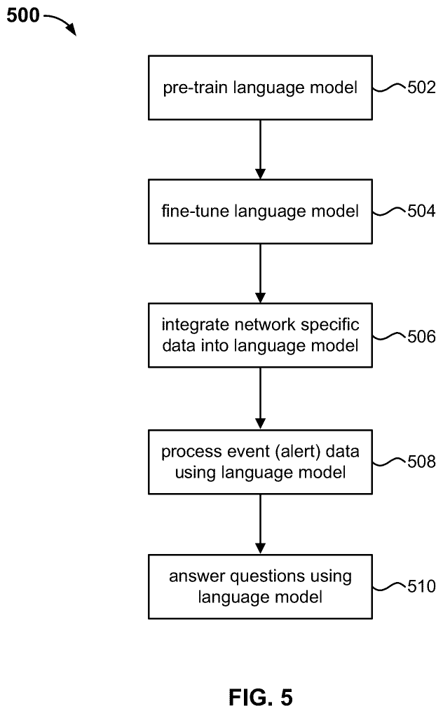

FIG. 5 is a high level flow chart illustrating an embodiment of a process for generating a language model. In some embodiments, process 500 is employed to train language model 404 of artificial intelligence based framework 400 of FIG. 4. Process 500 starts at step 502 at which a language model is pretrained using a large corpus of text related to network operations, network security, cybersecurity, and other related technology. The pretraining of step 502 provides the language model with a strong foundation in the domain knowledge required for understanding and communicating with experts in the field. As one example, the language model may comprise a GPT NeoX model. At step 504, the pretrained language model is fine-tuned with a more targeted model, such as a model designed specifically for cybersecurity applications, which helps the generated language model better understand the nuances and specific terminology used in the field. With respect to the given example, for instance, the pretrained GPT NeoX model of step 502 may be fine-tuned using BERT-based model secBERT to hone its focus on cybersecurity and network security tasks.

At step 506, network specific data is integrated into the language model. For example, step 506 may comprise importing network specific context (e.g., server names, device names, network segments, virtual private clouds, domain name systems, etc.) to tailor the language model to the unique environment of each network. Network specific data may be used to generate contextual prompts that enable the language model to accurately map network specific identifiers to IP addresses or other identifiers. At step 508, event data is processed using the language model. For example, step 508 may comprise ingesting and analyzing alert data, such as JSON (JavaScript Object Notation) alerts. As described, the language model learns specifics of the infrastructure of a network at step 506 and learns network and security events of the network at step 508. At step 510, questions formulated for the language model are answered by the language model. That is, once the language model has been fine-tuned and provided with the necessary context and event data, a series of questions developed for the language model to answer helps guide the language model in ultimately generating human-readable summaries, insights, and recommendations for different network stakeholders. In the given example, by combining features of multiple models (e.g., GPT NeoX and secBERT), a powerful language model capable of providing tailored and actionable insights to network stakeholders in the network and security operations and cybersecurity domains is generated using process 500. The training of the language model ensures that the language model is well-versed in both the broader context of technology and the specific nuances of security, enabling it to deliver accurate and relevant insights and recommendations.

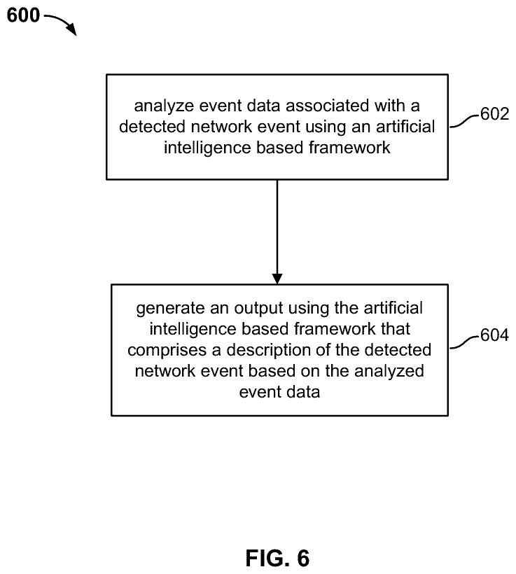

FIG. 6 is a high level flow chart illustrating an embodiment of a process for generating a description of a detected network event. In some embodiments, process 600 is employed by artificial intelligence based framework 400 of FIG. 4. Process 600 starts at step 602 at which an artificial intelligence based framework is used to analyze event data associated with a detected network event. For example, the event data may comprise alert or notification data associated with a network performance or network security event in a private network. In some embodiments, the artificial intelligence based framework comprises a cloud-based service that is external to a private network with which the detected network event is associated. For example, the artificial intelligence based framework may be a part of the disclosed network and security operations platform. The artificial intelligence based framework comprises one or more language models that may be trained using domain knowledge associated with network and security operations, network specific data that specifies infrastructures of one or more private networks, network and security event data associated with one or more private networks, etc.

At step 604, an output is generated using the artificial intelligence based framework that comprises a description of the detected network event based on the analyzed event data. The generated output, for example, may be based on analyzing a plurality of alerts or notifications generated in response to the detected network event. In various embodiments, the generated output may comprise a summary or report of the detected network event, insights associated with the detected network event, recommendations associated with remediating the detected network event, a master or super alert associated with the detected network event, a tag or label or metadata that describes the detected network event, etc. The generated output may be customized based on a user to whom the generated output is provided with different descriptions of the detected network event presented to different types of users.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
analyzing event data associated with a detected network event using an artificial intelligence based framework; and
generating an output using the artificial intelligence based framework that comprises a description of the detected network event based on the analyzed event data.

2. The method of claim 1, wherein the detected network event comprises a network performance event.

3. The method of claim 1, wherein the detected network event comprises a network security event.

4. The method of claim 1, wherein event data associated with the detected network event comprises alert or notification data.

5. The method of claim 1, wherein the generated output is based on analyzing a plurality of alerts or notifications generated in response to the detected network event.

6. The method of claim 1, wherein the generated output comprises a summary or report of the detected network event.

7. The method of claim 1, wherein the generated output comprises insights associated with the detected network event.

8. The method of claim 1, wherein the generated output comprises recommendations associated with remediating the detected network event.

9. The method of claim 1, wherein the generated output is customized based on a user to whom the generated output is provided with different descriptions of the detected network event presented to different types of users.

10. The method of claim 1, wherein the generated output comprises a master or super alert associated with the detected network event.

11. The method of claim 1, wherein the generated output comprises a tag or label that describes the detected network event.

12. The method of claim 1, wherein the artificial intelligence based framework comprises one or more natural language processing (NLP) models.

13. The method of claim 1, wherein the artificial intelligence based framework comprises one or more large language models (LLMs).

14. The method of claim 1, wherein the artificial intelligence based framework is trained at least in part on domain knowledge associated with network and security operations.

15. The method of claim 1, wherein the artificial intelligence based framework is trained at least in part on network specific data that specifies infrastructures of one or more networks.

16. The method of claim 1, wherein the artificial intelligence based framework is trained at least in part on network and security event data associated with one or more networks.

17. The method of claim 1, wherein the artificial intelligence based framework comprises an external, cloud-based service that is external to a private network with which the detected network event is associated.

18. The method of claim 1, wherein the artificial intelligence based framework comprises a network and security operations platform.

19. A system, comprising:
a processor configured to:
analyze event data associated with a detected network event using an artificial intelligence based framework; and
generate an output using the artificial intelligence based framework that comprises a description of the detected network event based on the analyzed event data; and
a memory coupled to the processor and configured to provide the processor with instructions.

20. A computer program product embodied in a non-transitory computer readable medium and comprising computer instructions for:
analyzing event data associated with a detected network event using an artificial intelligence based framework; and
generating an output using the artificial intelligence based framework that comprises a description of the detected network event based on the analyzed event data.
